(19) United States
(12) Patent Application Publication
(10) Pub. No.: US 2015/0037086 A1
(43) Pub. Date: Feb. 5, 2015

(54) THREAD-REINFORCED AXIAL COUPLING

(71) Applicants: Marc Brandl, Burgkirchen (DE); Martin Wieser, Kraiburg (DE); Josef Stubenrauch, Rott Am Inn (DE); Josef Scheitzeneder, Kraiburg (DE); Hubert Kaiser, Oberndorf (DE); Bernd Scheper, Reichertsheim (DE)

(72) Inventors: Marc Brandl, Burgkirchen (DE); Martin Wieser, Kraiburg (DE); Josef Stubenrauch, Rott Am Inn (DE); Josef Scheitzeneder, Kraiburg (DE); Hubert Kaiser, Oberndorf (DE); Bernd Scheper, Reichertsheim (DE)

(73) Assignee: SGF Sueddeutsche Gelenkscheibenfabrik GmbH & Co. KG, Waldkraiburg (DE)

(21) Appl. No.: 14/003,038

(22) PCT Filed: Feb. 28, 2012
(86) PCT No.: PCT/EP2012/000864

§ 371 Date: Oct. 4, 2013

(30) Foreign Application Priority Data
Mar. 4, 2011 (DE) 10 2011 013 050.0

(51) Int. Cl. F16D 3/50; F16D 3/12

(52) U.S. Cl. CPC F16D 3/50; F16D 3/12
USPC 403/220

(57) ABSTRACT

The present disclosure relates to a coupling for transmitting forces, acting along a longitudinal axis, between two attachment components, having two coupling parts, which are disposed along the longitudinal axis and which each have a connection region and a coupler region, the connection regions of the two coupling parts facing towards each other, and the two coupler regions being connectable to a respective attachment component. The two connection regions are connected to each other via at least one loop packet, which transmits forces, acting along the longitudinal axis, between the coupling parts.

The present invention relates to a coupling for transmitting forces, acting along a longitudinal axis, between two attachment components, comprising two coupling parts, which are disposed along the longitudinal axis and which each have a connection region and a coupler region, the connection regions of the two coupling parts facing towards each other, and the two coupler regions being connectable to a respective attachment component.

Such couplings are known from the prior art and are frequently also termed axial couplings. Thus, for example, the document DE 100 10 804 A1 describes an axial coupling that is suitable, in particular, for transmitting linear motions. This coupling enables a first shaft portion to be connected to a second shaft portion, the coupling comprising two metallic spring elements and an intermediate piece disposed between the latter. The coupling allows linear motions to be transmitted, even if the two axes are not in alignment with each other along the longitudinal axis, or are even at an angle in relation to each other. Such misalignments of the two axial portions to be connected to each other can be compensated by means of such a coupling, the coupling being largely free from backlash. However, it has been found that, in practice, such couplings are relatively vulnerable and, particularly if high forces are to be transmitted, and in the case of axially acting vibratory loads or shock loads, have a short service life. This is due to the fact that the forces are ultimately transmitted via the metallic spring elements, which are subject to tensile and compressive loading and—precisely in the case of repeatedly occurring vibrations or shocks—do not withstand this loading over a long duration.

Additionally known from the prior art are linear couplings that are realized in the form of a claw coupling. Such couplings are disclosed by, for example, the utility model DE 20 2008 000 772 U1. Such claw couplings are preferably used for torque transmission, however, and have only limited suitability for the transmission of axial force. This requires separate provisions such as, for instance, connecting pins, which then limit the application possibilities.

The present invention is based on the object of providing a coupling, of the type designated at the outset, that overcomes the problems described above and has a considerably greater service life.

This object is achieved by a coupling, of the type designated at the outset, in which it is provided that the two connection regions are connected to each other via at least one loop packet, which transmits forces, acting along the longitudinal axis, between the coupling parts. It has been found that the use of loop packets for connecting the two connection regions of the coupling parts renders possible a considerable increase in the service life. Loop packets allow the two coupling parts to be decoupled in respect of vibration and, for the transmission of force, are therefore less critical than a fixed connection via spring elements, as used in the prior art. Consequently, vibration peaks and shocks can be reduced. The use of loop packets is already known in principle in the prior art. For example, disc joints, via which the torques are transmitted between two shaft portions, have long been used in motor vehicle applications, but also in industrial applications. In these cases, it has been found that these disc joints can be reinforced by thread loops in regions that are subjected to tensile loading during the transmission of torque, the thread loops—embedded in elastomer material—being able to transmit high tensile forces. In the case of disc joints, likewise, the advantage of decoupling in respect of vibration applies.

It has now been identified by the applicant that this principle can also be applied in the case of axial couplings, it being possible to exploit the advantage of compensation of an axial offset and, owing to the decoupling in respect of vibration, and the associated reduction of the transmission of structure-borne sound, to substantially increase the loading capacity of the coupling. During the transmission of axial forces, for example in the case of a reciprocating motion, tensile forces and compressive forces are transmitted. Preferably, in the context of the present invention, it is provided that the at least one loop packet is provided for transmitting tensile forces, acting along the longitudinal axis, between the two coupling parts. Alternatively or additionally, transmission of compressive force between the two coupling parts can also be achieved by appropriate disposition of one or more further loop packets.

For the purpose of attaching the at least one loop packet, a development of the invention provides that the at least one loop packet is fitted on to each coupling part via a respective mounting means, so as to transmit force. It can be provided in this case that the mounting means in each case is constituted by a pin that extends out from the coupling part, transversely in relation to the longitudinal axis. It is possible for the pin to be disposed directly on the coupling part and to extend out integrally from the latter. Alternatively, however, the pin can also be realized as a separate component, and can be inserted in a non-positive or positive manner in a corresponding receiving opening in the respective coupling part. However, it is also possible, according to the invention, to provide other mounting means on the respective coupling part, for example hooks, local projections, recesses, etc.

Depending on the nature of loading on the coupling, forces of a greater or lesser magnitude have to be transmitted. In order to increase the loading capacity of the coupling, a development of the invention provides that a plurality of loop packets are used, which connect the two coupling parts to each other so as to transmit force.

In this context, it can be provided that a respective mounting means, on to which a respective loop packet is fitted, is provided on at least one coupling part, at diametrically opposite positions. This means that the individual loop packets of the plurality of loop packets are disposed uniformly in the structural space of the coupling according to the invention. It can be provided in this case that the loop packets are offset at angular distances in relation to each other in the circumferential direction. However, the loop packets can also be nested in each other or intersect each other.

A development of the invention provides that at least two loop packets extend substantially parallelwise in relation to the longitudinal axis. This is preferred, in particular, because the transmission of force is usually effected in the direction of the longitudinal axis. It is also possible, however, for at least one loop packet to extend obliquely or in a curved manner in relation to the longitudinal axis. As a result, the loop packets can be spatially disposed such that their extent runs both in the axial direction and in the circumferential direction, such that the loop packets can also be used to transmit torques between the coupling parts. This is necessary, for example, if the coupling is to be used to transmit both torques and linear motions, for example in the case of the transmission of helical or wobble motions.

As already indicated above, it is frequently necessary to transmit motions in two opposing directions by means of such axial couplings, such that there is tensile and compressive loading in the coupling. Thus, a development of the invention can provide that at least one compression body, for transmitting compressive forces acting along the longitudinal axis, is disposed between the two coupling parts. It is possible in this case for the at least one compression body to comprise a compression pin, which is fixed to one of the two coupling parts and presses against the other of the two coupling parts. The compression body therefore thus effects relatively rigid coupling of the two coupling parts for the purpose of transmitting compressive force. In this case, the compression body itself can be realized so as to be relatively stiff or rigid. Alternatively, however, it is also possible for the at least one compression body to comprise a spring means, preferably an elastomer layer, or to be made entirely of elastomer material. The decoupling of the coupling parts in respect of vibration is thereby enhanced. Depending on the requirement, the spring means can be set in respect of their spring hardness.

In a simple design of the invention, the two coupling parts are directly coupled to each other via loop packets and, if appropriate, via a compression body. In order to fulfil more complex tasks, however, an additional force transmission arrangement can also be disposed between the two coupling parts. It is thus provided, according to the development of the invention, that provided in the force transmission path between the two coupling parts there is at least one transmission part, which is respectively connected, via at least one loop packet, to at least one of the two coupling parts, so as to transmit force. Such a transmission part makes it possible, for example, for differing loop packets to be disposed such that, via the latter, both tensile forces and compressive forces can be transmitted between the two coupling parts. This is described in greater detail in the description of the figures. The transmission parts can be hollow, in order to position, or guide, the differing loop packets in their alignment and direction of force transmission. It can be provided in this case that the compression body goes through the at least one transmission part. It is thus possible for a transmission part to be hollow in form, in order, for instance, for a single loop packet, or a plurality of loop packets, to extend through the latter. For the same purpose, it can also be provided with lateral recesses. It is possible, in principle, for the coupling to be of a relatively open design. Preferably, however, the coupling should be encapsulated.

This can be achieved in that a sleeve body is provided, which at least portionally surrounds at least one of the coupling parts, and which is provided with radially inwardly projecting mounting means, on to which a respective loop packet is fitted, so as to transmit force.

Further, it is possible for the sleeve body to be connected to one of the coupling parts so as to transmit force. The sleeve body can be integral with one of the coupling parts and/or realized as a separate component.

It is also possible for the loop packets disposed inside the coupling to be encapsulated, in that an elastomer body, in which the at least one loop packet is embedded, is disposed between the two coupling parts. This can be achieved, for example, in that the coupling parts are first connected to each other via the loop packets provided for this purpose, and the region between the two coupling parts is then filled, or spray-coated, with an elastomer material so as to achieve overall a compact, encapsulated structure of the coupling.

A development of the coupling according to the invention provides that the coupling has various stops. These stops can be provided to limit an axial motion, but also to limit a radial motion in the case of torque transmission.

The invention is explained exemplarily in the following on the basis of the accompanying figures, wherein:

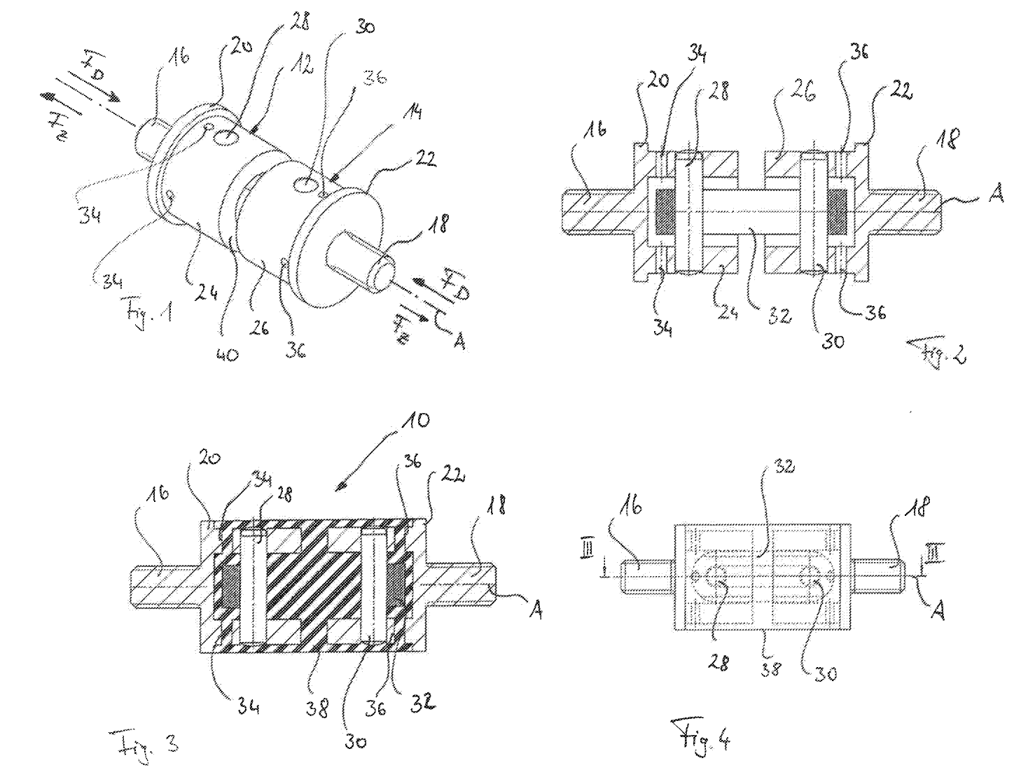

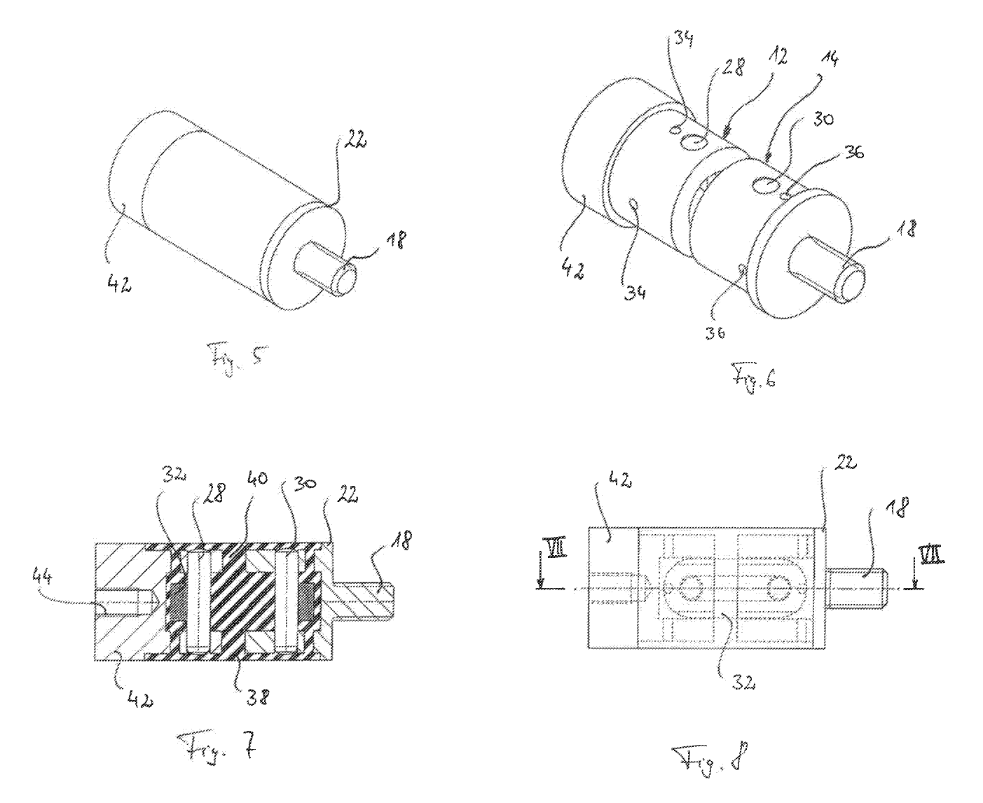

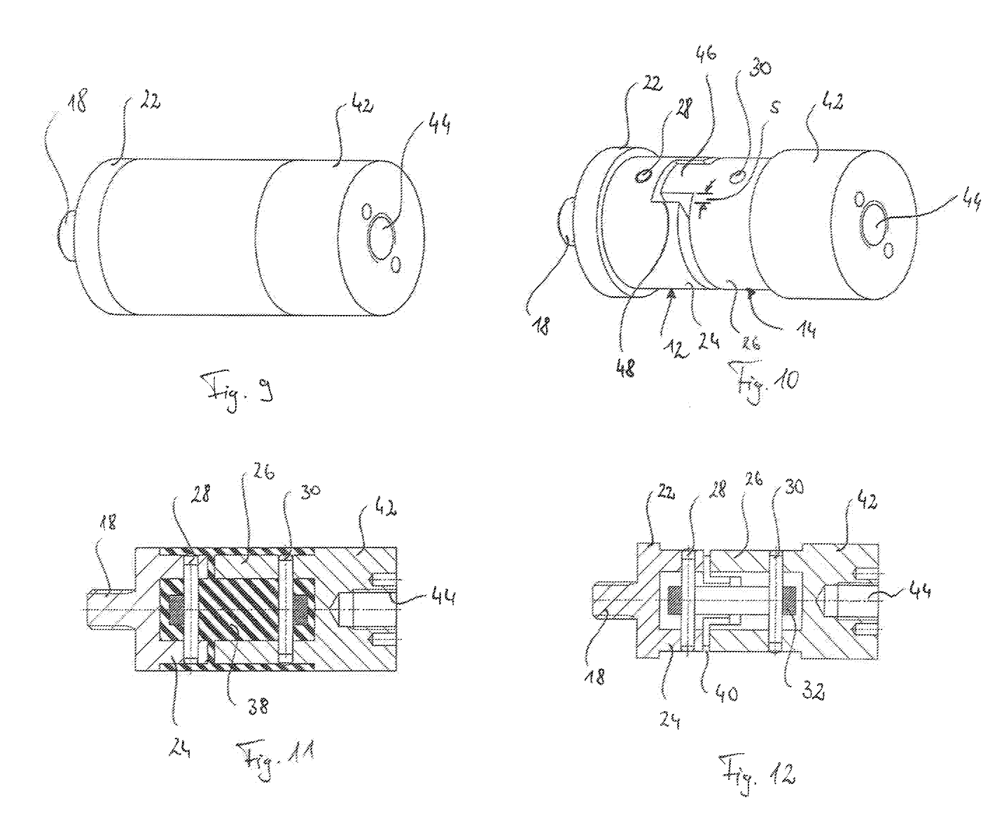

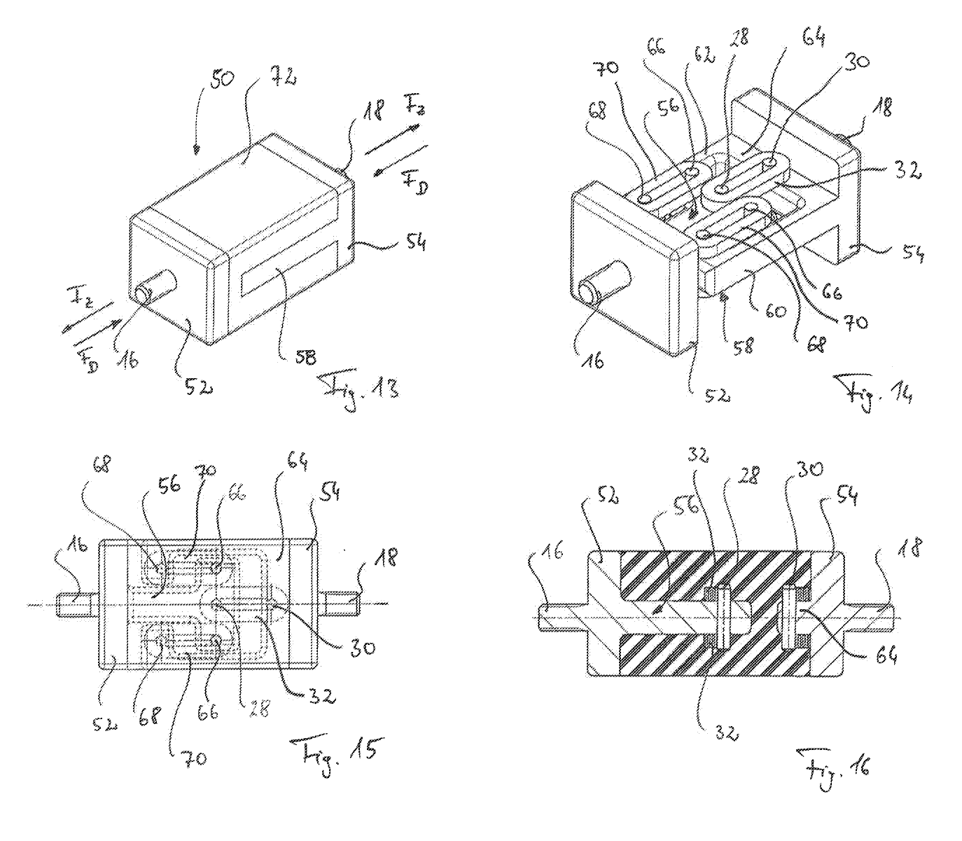

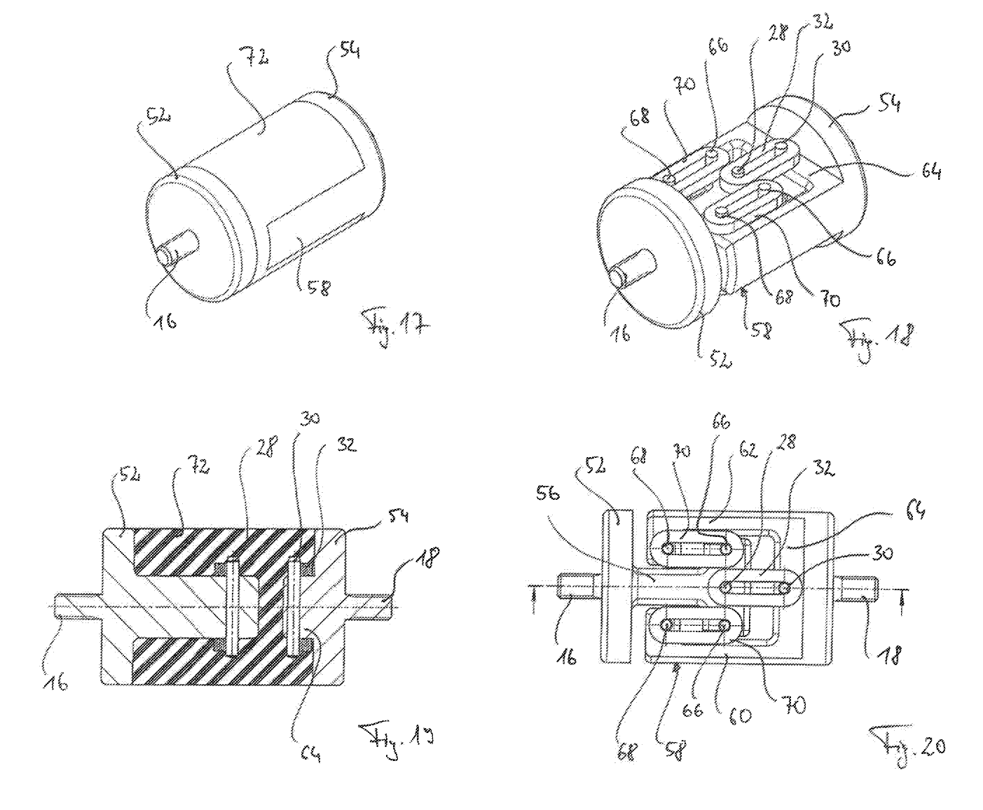

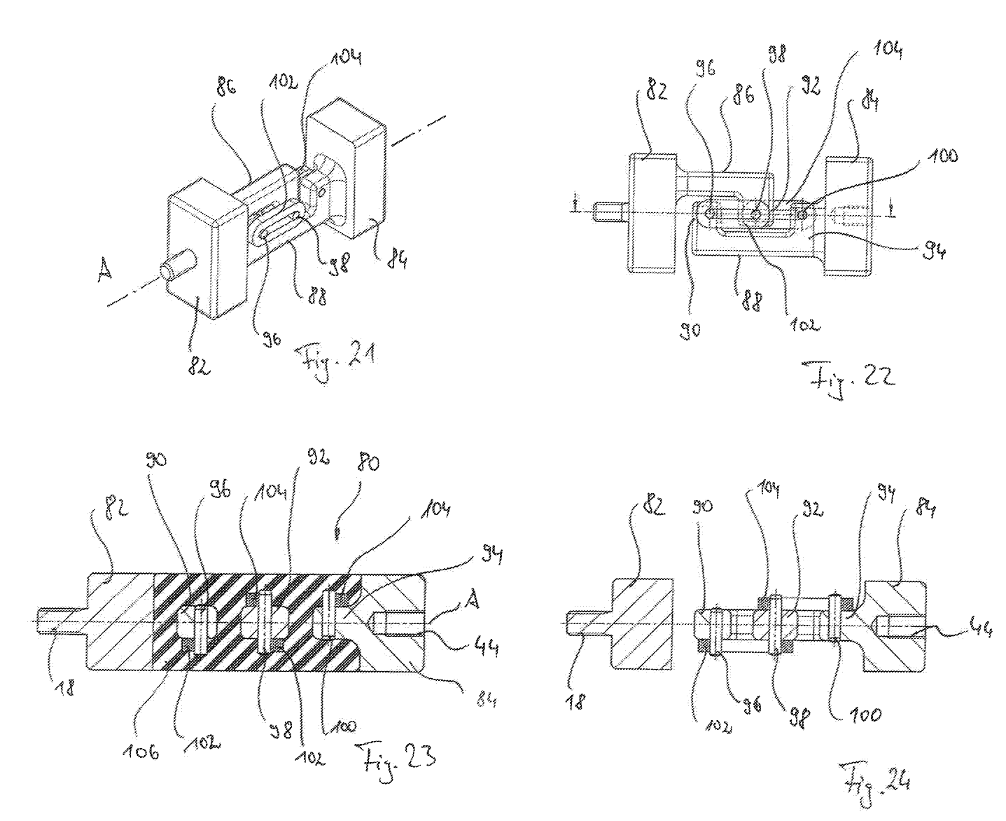

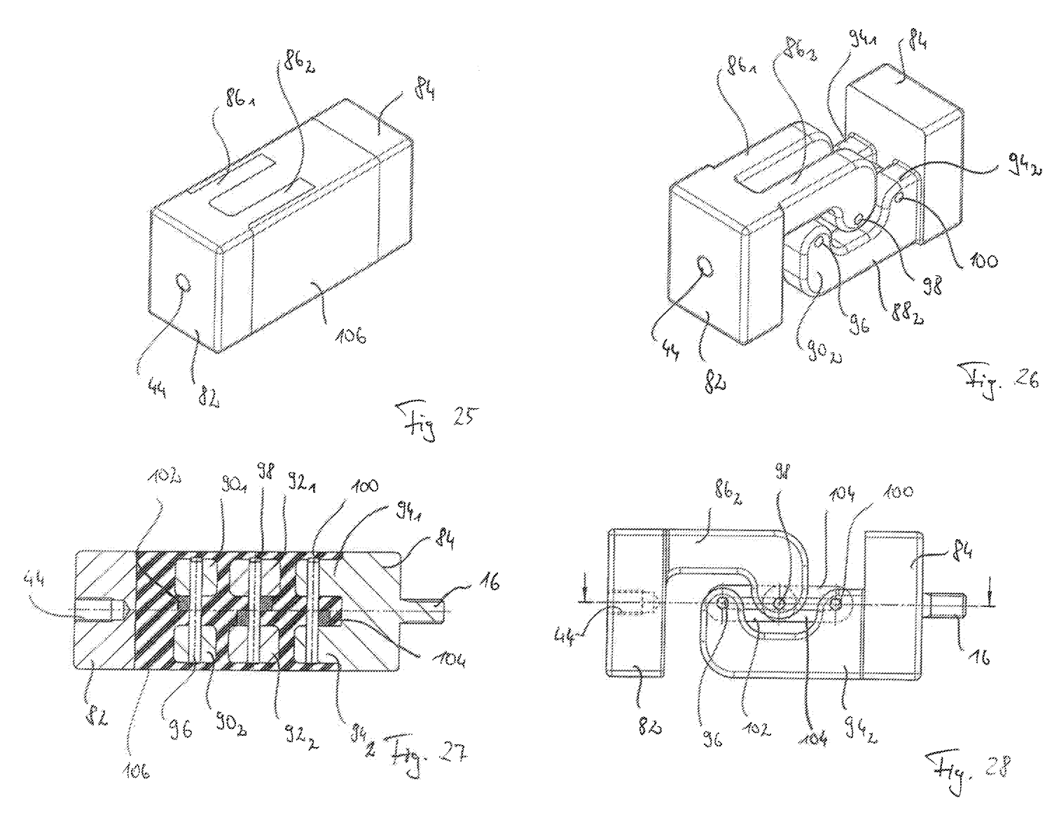

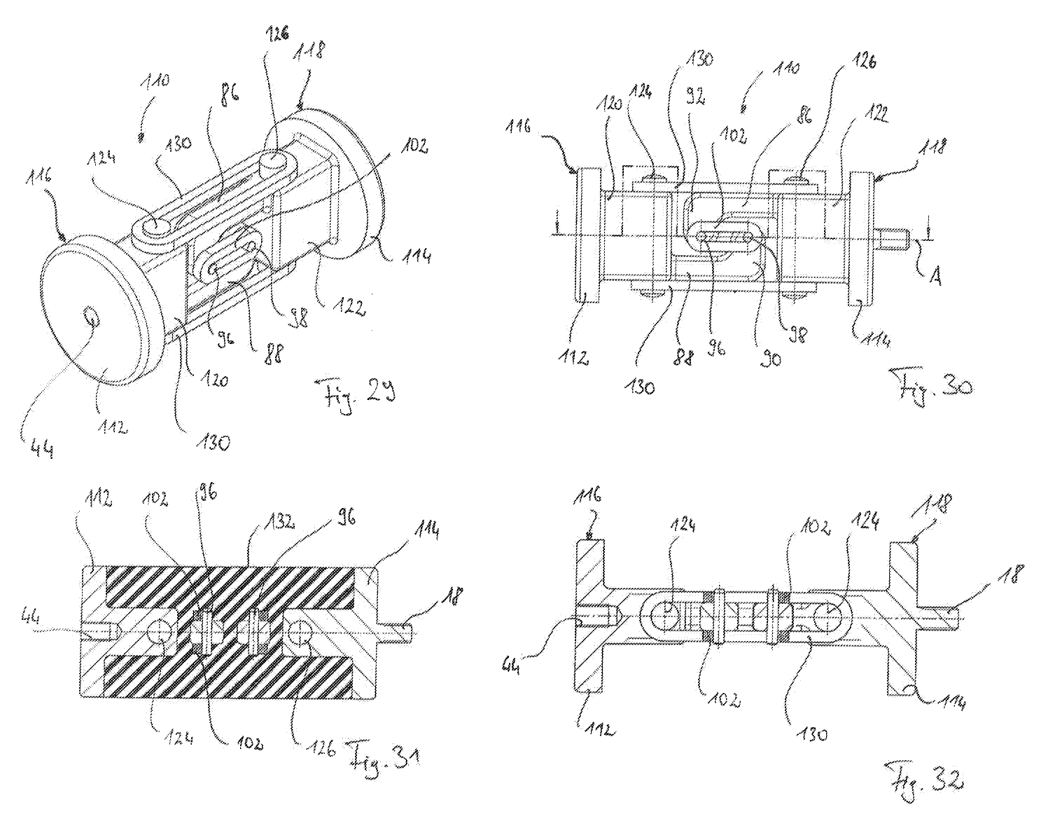

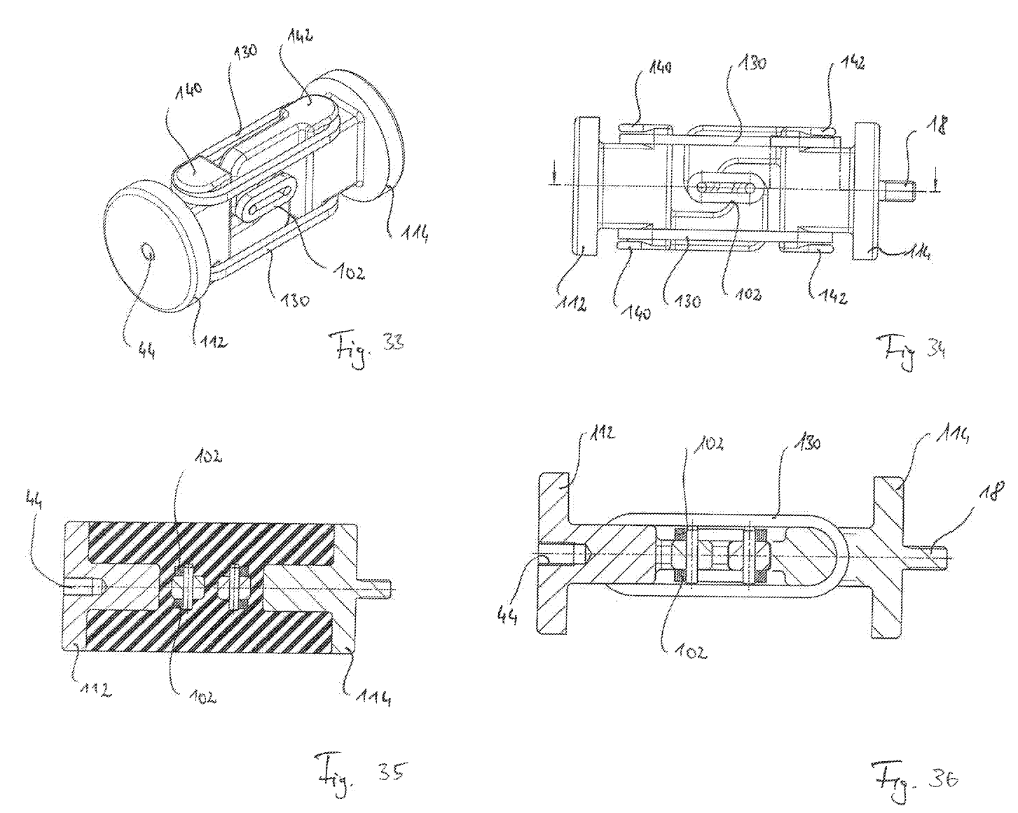

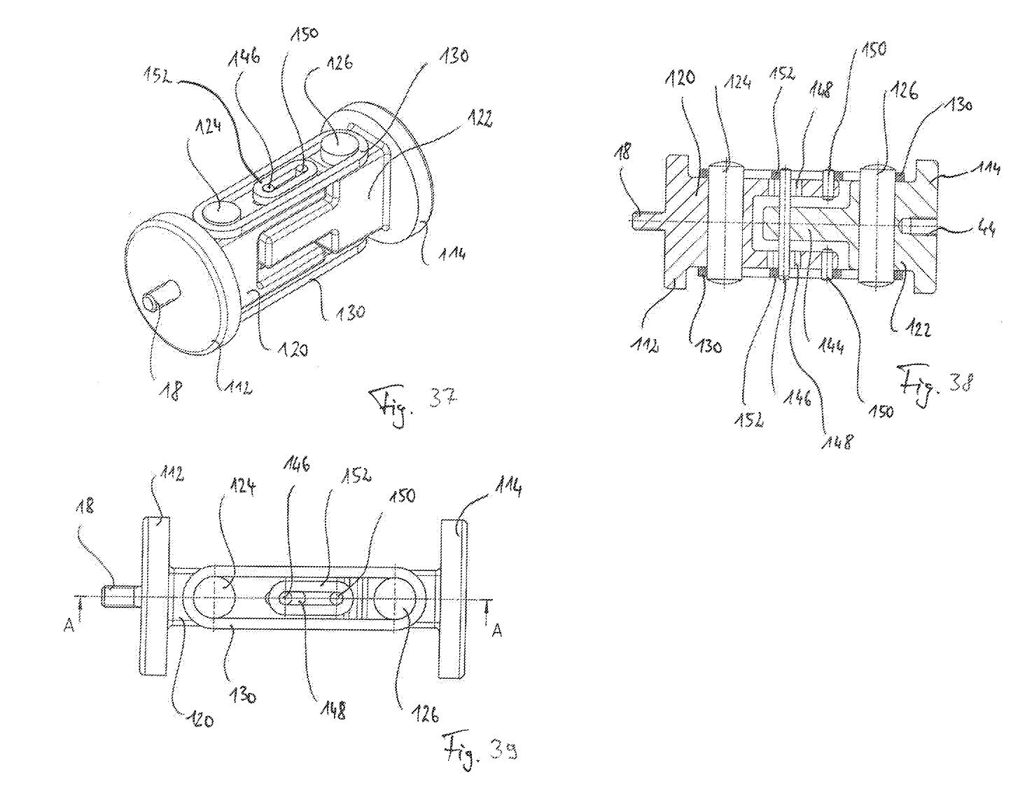

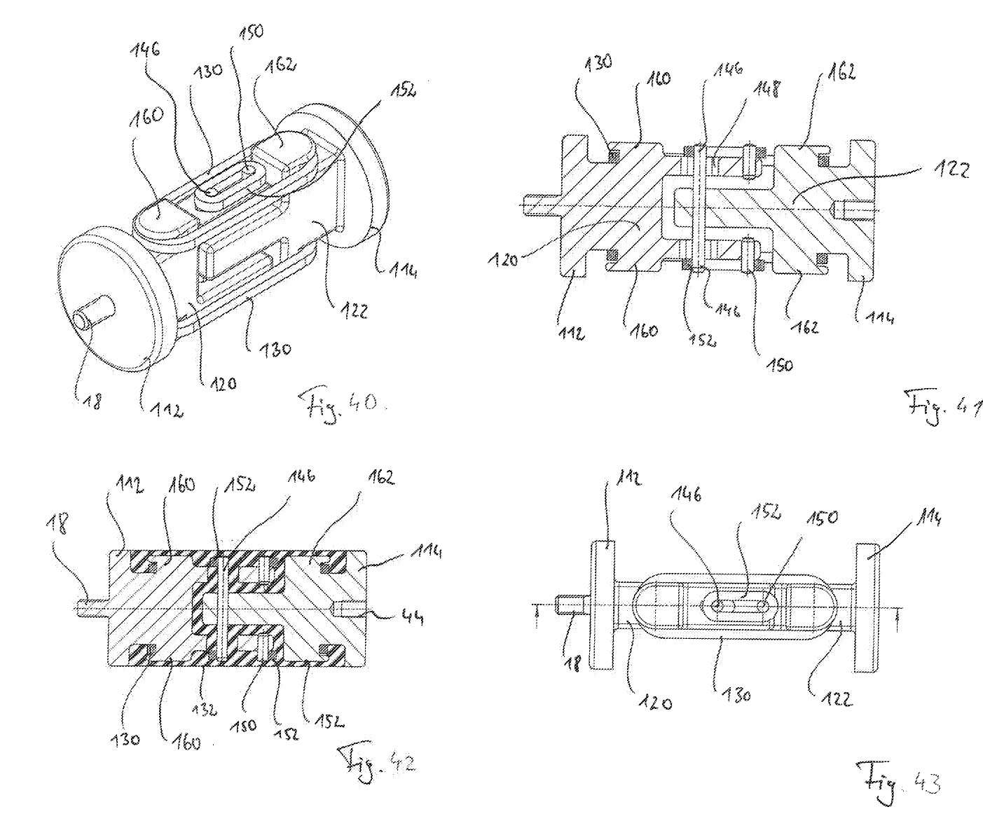

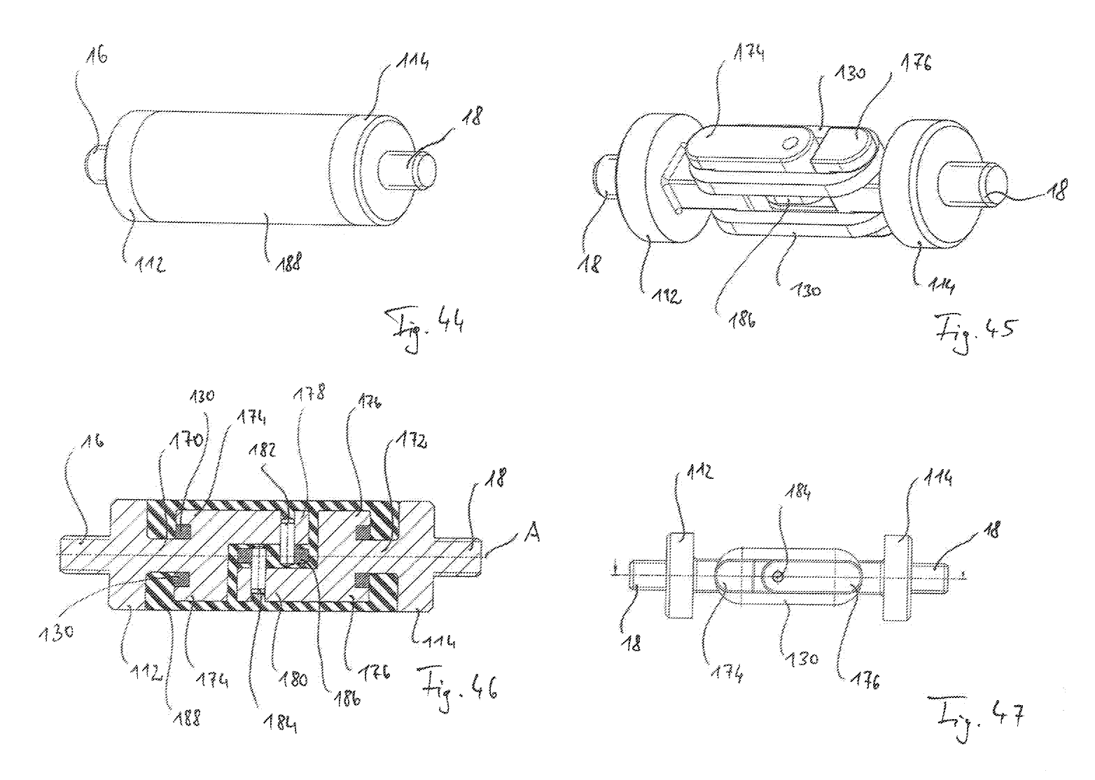

FIGS. 1-4 show various representations of a first exemplary embodiment of a coupling according to the invention;

FIG. 5-8 show various views of a second exemplary embodiment of a coupling according to the invention;

FIGS. 9-12 show various representations of a third exemplary embodiment of a coupling according to the invention;

FIGS. 13-16 show various representations of a fourth exemplary embodiment of a coupling according to the invention;

FIGS. 17-20 show various representations of a fifth exemplary embodiment of a coupling according to the invention;

FIGS. 21-24 show various representations of a sixth exemplary embodiment of a coupling according to the invention;

FIGS. 25-28 show various representations of a seventh exemplary embodiment of a coupling according to the invention;

FIGS. 29-32 show various representations of an eighth exemplary embodiment of a coupling according to the invention;

FIGS. 33-36 show various representations of a ninth exemplary embodiment of a coupling according to the invention;

FIGS. 37-39 show various representations of a tenth exemplary embodiment of a coupling according to the invention;

FIGS. 40-43 show various representations of en eleventh exemplary embodiment of a coupling according to the invention;

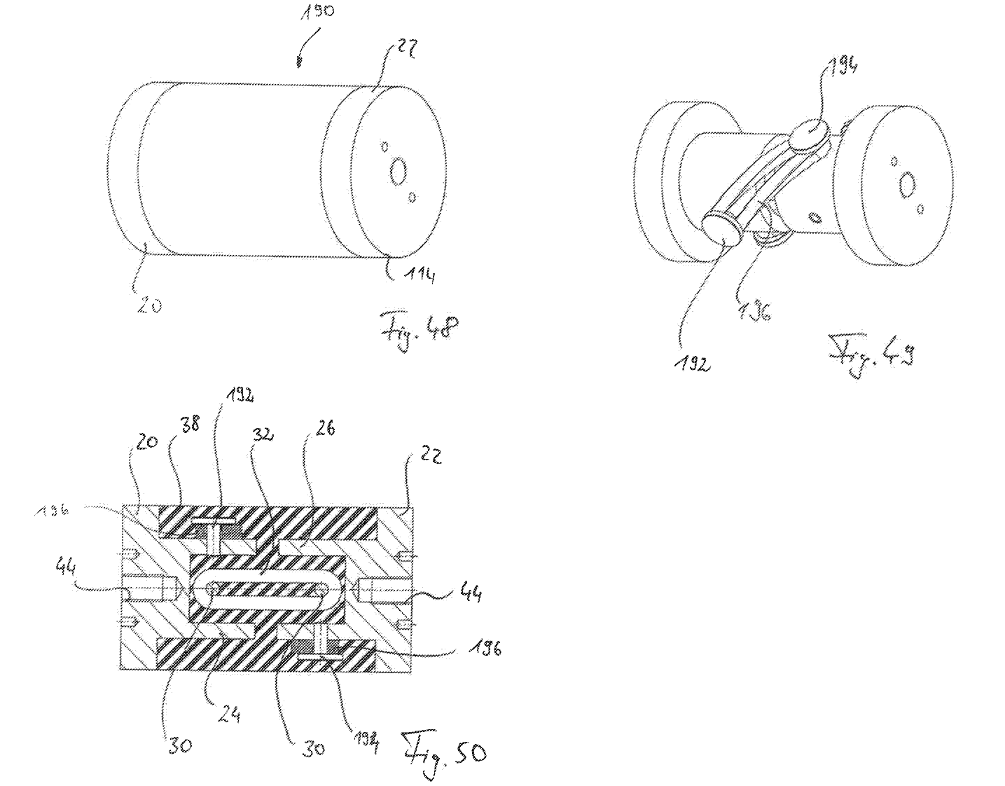

FIGS. 44-47 show various representations of a twelfth exemplary embodiment of a coupling according to the invention;

FIGS. 48-50 show various representations of a thirteenth exemplary embodiment of a coupling according to the invention;

FIGS. 51-54 show further schematic representations relating to embodiments.

The first exemplary embodiment according to FIGS. 1 to 4 shows a coupling, which is denoted in general by 10, with FIG. 3 showing a longitudinal sectional view that includes an axis, and FIGS. 1 and 2, for the purpose of illustration, showing the arrangement without elastomer. This coupling comprises a first coupling part 12 and a second coupling part 14. At their ends that face away from each other, the two coupling parts 12 and 14 each have screw-threaded portions by means of which they can be coupled, for example, to shaft portions, not shown, or to other components. These screw-threaded portions 18, 20 are denoted by 16 and 18. The screw-threaded portions are formed on to flanges 20, 22, from which tubular portions 24, 26 extend towards each other. On the sides that face towards each other, these tubular portions 24, 26 are realized with an axial opening. Extending in each tubular portion 24 and 26, transversely in relation to a longitudinal axis A, there is a fastening pin 28, 30, which is accommodated positively with a press fit in corresponding openings in the tubular portions 24, 26. A thread packet 32 of nylon threads or the like is wound around these pins 28, 30. The thread packet 32 extends in a taut manner around the two pins 28, 30. It can additionally be seen that, disposed in the tubular portions 24, 26, close to the flange 20, 22, there are respective bores 34 and 36, disposed at angular distances in relation to each other.

It can be seen in FIG. 3 that, between the two flanges 20, 22, the entire arrangement is spray-coated with an elastomer material 38. This means that the elastomer material 38 fills in both the outer circumferential surfaces of the two tubular portions 24 and 26 and also the space 40 between the two coupling parts 12 and 14, but also the inside space, and surrounds the loop packet 32. Overall, a substantially circular-cylindrical body is obtained, the elastomer material 38 being substantially flush with the outer circumferential surfaces of the flange portions 20, 22. The inner region, in particular the region inside and around the thread packet 32, is also filled with elastomer material.

The coupling 10 according to the first exemplary embodiment is provided, in particular, to transmit tensile forces F_{Z} and compressive forces F_{D} between two components (shaft portion), which are attached to the coupling 10 by means of the screw-thread 16, 18. The tensile forces F_{Z} are transmitted via the loop packet 32, which is mounted on the two pins 28, 30 so as to transmit tensile force. The compressive forces F_{D} are transmitted via the elastomer layer 38, which is disposed between the two coupling parts 12 and 14, and fully vulcanized. The loop packet 32 is designed to transmit high tensile forces. Obtained overall is a coupling 10 that can compensate (cardanic motion) an offset and an inclination of the two components (shaft portions) attached to the screw-threads 16 and 18 for the purpose of transmitting high tensile forces, and that is designed according to high compressive forces and has a long service life. The encapsulation by the elastomer material 38 is also instrumental in this.

The second embodiment according to FIGS. 5 to 8 is realized in a manner similar to that of the first embodiment, with FIG. 7 showing a longitudinal sectional view and FIG. 6, for the purpose of illustration, showing the arrangement without elastomer. Only the differences are described in the following. The same references as in the description of the first embodiment are used for components that operate in the same manner or that are of the same type. It can be seen that the combination of a screw-thread 16 and a flange 20 has been replaced by a cylindrical body 42, which represents a widening of the flange 20. Let into the cylindrical body 42 there is an internal screw-thread 44, provided to receive a corresponding threaded pin, for attaching a shaft portion or the like. Otherwise, the structure of the embodiment according to FIGS. 5 to 8 is the same as the structure of the first embodiment according to FIGS. 1 to 4. In particular, the mounting of the loop packet 32 on the pin 28, 30 and the covering with elastomer material 38 are identical. The elastomer material 38 again fills in the entire space between the two coupling parts 12, 14 and surrounds the region between the cylindrical component 42 and the flange 22, such that it acts as a compression body for transmitting compressive force.

FIGS. 9 to 12 shows a third embodiment of the invention, which is substantially the same as the embodiment according to FIGS. 5 to 8, with FIG. 12, for the purpose of illustration, representing the structure in a longitudinal sectional view without elastomer material. This embodiment, however, differs in that the two coupling parts 12 and 14 engage in each other, with their tubular portions, in a claw-like manner, the coupling part 14 having two diametrically opposite claws 46 that project in the axial direction, and the coupling part 12 having corresponding recesses 48, the claws 46 projecting into the recesses 48 with sufficient play s. The claws 46 and the recesses 48, by means of the gap s enclosed between them, define a motion clearance in respect of a relative rotation of the two coupling parts 12 and 14 and in respect of a maximum axial approach. This also applies to the state shown in FIG. 11, in which the coupling parts 12 and 14 have been spray-coated with elastomer material 38. By means of the claws 46 and the recesses 48, the two coupling parts 12 and 14 are thus secured against rotation relative to each other. Otherwise, the coupling functions in exactly the same way as the coupling according to FIGS. 5 to 8. The transmission of tensile force is effected via the loop packet 32, and the transmission of compressive force is effected via the elastomer body 38.

FIGS. 13 to 16 show a further embodiment of an axial coupling 50 according to the invention. This coupling is no longer circular-cylindrical in its basic shape, but is instead rectangular. Again, it has a first coupling part 52 and a second coupling part 54. The first coupling part 52 has a central T-shaped projection 56. The second coupling part 54 has a U-shaped projection 58, which has a first U-limb 60 and a second U-limb 62 and has a base 64. It can be seen that a central pin 28 and two outer pins 66 are provided in the transverse limb of the T-shaped portion 56. A further pin 30 is provided in the base 64 of the U-shaped projection 58. Further pins 68 are disposed at the free ends of the two limbs 60 and 62, which are each bent somewhat inwards. Again, these pins are accommodated positively in a press fit in the respective coupling parts 52 and 54. Loop packets are mounted on each of the pins. The two coupling parts 52 and 54 are thus connected by two loop packets 32, which, in the case of tensile loading, are subjected to tensile loading by corresponding tensile forces F_{Z}, and thus enable force to be transmitted. Further, the two coupling elements 52 and 54 are connected to each other by loop packets 70, via the pins 66 and 68. This disposition is selected in such a manner that, in the case of compressive forces F_{D}, the loop packets transmit the compressive forces. The disposition of the pins 66 and 68 on the projections 56 and 58 is selected in such a manner that, in the case of such compressive-force loading, the loop pairs 70 themselves, in turn, are subjected to tensile loading.

It can additionally be seen that the region between the two plate-type ends of the coupling parts 52 and 54 is again filled with elastomer material 72. In the case of this embodiment of the coupling, the transmission of both tensile forces and compressive forces is effected via differing loop packets.

The embodiment according to FIGS. 17 to 20 shows an arrangement corresponding to the embodiment according to FIGS. 13 to 16, but again in a circular-cylindrical form, rather than in a rectangular form. It can be seen from the circular-cylindrical outer circumferential surface, however, that the disposition of the pins and loop packets, and of the projections 56 and 58, is identical to that of the embodiment according to FIGS. 13 to 16. It is to be noted that FIG. 19 represents the section, including the axis, through FIG. 20.

FIGS. 21 to 24 show a further embodiment of the invention, in which the coupling 80 is again designed to transmit both tensile forces and compressive forces, along its longitudinal axis A, via loop packets. Again, two coupling parts 82 and 84 are provided, from which there extend, respectively, central projections 86 and 88 that have a hook-shaped course, as can be seen in the view according to FIG. 22. At their free ends, the two projections 86 and 88 are each bent at an angle, such that the projections 90, 92 are obtained. The projection 88 additionally has a base 94. Pins 96, 98, 100 are provided, approximately on the common central axis A. The pins 96 and 98 are connected by a loop packet 102 on the one side of the projections 86, 88. The pins 98 and 100 are connected to each other by a second loop packet 104. Again, the space between the two coupling parts 82 and 84 is filled in with an elastomer material 106. The loop packet 102 serves to transmit compressive forces. If, for example, the coupling component 82 presses in the axial direction towards the coupling component 84, the loop packet 102 is subjected to tensile loading, which results in transmission of compressive force. On the other hand, the loop packet 104 is used for transmitting tensile force. It is to be noted that FIGS. 23 and 24 are each sectional views, including axes, from FIG. 22, one with elastomer 106 and one without elastomer.

The embodiment according to FIGS. 25 to 28 shows a modification of the embodiment according to FIGS. 21 to 24, with FIG. 25 being the coupling as a whole, FIG. 26 being a view corresponding to FIG. 21, without an elastomer body, and FIG. 28 being a side view, from the right, of FIG. 26. FIG. 27 represents a sectional view corresponding to the section line from FIG. 28, but with an elastomer body.

It can be seen that this coupling has two projections 86₁ and 86₂, and 88₁ and 88₂. These projections engage in each other in the manner of hooks, in the same manner as that described for the coupling according to FIGS. 21 to 24. However, the loops are not disposed on both sides of the hooks, but in the space between the two hooks, as shown, for example, in FIG. 27. Thus, the pins 96, 98 and 100 can be to carried at two locations, on opposing hooks, and the loop packets 102 and 104 can be mounted inside these hooks and inside the mounting locations. The functioning is the same as that described with reference to FIGS. 21 and 24. Tensile forces are transmitted via the loops 104, and compressive forces are transmitted via the loops 102 and the corresponding pins. The elastomer layer 106 likewise serves to transmit compressive force, and allows a certain flexibility of displacement of the two coupling parts 82 and 84 in relation to each other.

The embodiment according to FIGS. 29 to 32 is a development of the embodiment according to FIGS. 21 to 24. The views of FIGS. 29 to 32 according to the views according to FIGS. 21 to 24. The coupling 110 according to FIGS. 29 to 32 again comprises two circular-cylindrical, flange-type bodies 112, 114 on the two coupling parts 116, 118. Provided on these two flange parts there are projections 120, 122, projecting from which, again, there are hooks 86 having transversely extending projections 90 and 92. Two loop packets 102 are mounted on these transversely extending projections, via corresponding pins 96 and 98, on both sides of the hooks. Offset by 90° in relation to the longitudinal axis A, on the projections 120 and 122, further fastening pins 124, 126 are accommodated with a press fit in corresponding bores, which fastening pins each project on both sides. Again, two loop packets 130 are fastened to these pins 124 and 126. The entire arrangement is again surrounded by an elastomer compound 132 (see FIG. 31) between the two flanges 112 and 114. The two loop packets 102 serve to transmit compressive force. The two loop packets 130 serve to transmit tensile force. Owing to the provision of a plurality of loop packets, namely two in each case, for the compressive-load path and the tensile-load path, this coupling is suitable for the transmission of large amounts of force.

The embodiment according to FIGS. 33 and 36 is similar to the embodiment according to FIGS. 29 to 32, but with the loop packets 130 for transmitting tensile force not being mounted on separately attached pins, but on formed-on projections 140, 142. These projections 140 and 142 have offsets in the region in which the loop packet 130 is carried, to enable the loop packet to be mounted therein. Otherwise, the structure and the functioning of the coupling according to the exemplary embodiment according to FIGS. 33 to 36 is the same as those of FIGS. 29 to 32.

In a manner similar to that of the embodiments according to FIGS. 31 to 36, the embodiment according to FIGS. 37 to 39 provides respectively two loop packets for the tensile path and the compressive-load path. However, the loop packets are disposed so as to be, as it were, nested in each other. It can be seen that the projection 120 is realized in a U shape, and the projection 122 has a portion 144 that projects centrally into the U recess of the projection 120. A long pin 146 is accommodated with a press fit in this portion 144. This pin is displaceably guided through an elongate recess 148 in the two U limbs of the projection 120. Further fastening pins 150 are provided at the free end of each of the two U limbs. On both sides of the projections 120 and 122, two loop packets 152 are guided around the pins 146 and 150. Moreover, on both sides of the projections 120 and 122, two loop packets 130 that surround these loop packets 152 are guided around the two pins 124 and 126. The loop packets 130 serve to transmit tensile load, whereas the loop packets 152 serve to transmit compressive load. In both cases, the pin 146 can move in the oblong holes 148 if there is displacement of the two coupling parts 112 and 114 in relation to each other.

The embodiment according to FIGS. 40 to 43 is similar to the embodiment according to FIGS. 37 to 39. However, the pins 124, 126 have been replaced by fastening projections 160, 162, which are formed on to the projections 120 and 122 and have corresponding offsets for receiving the thread packet 130.

The embodiment according to FIGS. 44 to 47 shows a further arrangement, in which thread packets are used both in the tensile-load path and in the compressive-load path. Respective projections 170, 172 are formed on to the two coupling parts 112 and 114. These projections have projections 174, 176 that face radially outwards. The loop packets 130 are mounted in these projections. The two projections 170 and 172 extend, overlapping each other, above and below the central axis A (see FIGS. 45 and 46), in overlap regions 178, 180. Respective fastening pins 182, 184 are disposed in these overlap regions. Disposed in the space between the overlap regions 178, 180 is a further loop packet 186, which is mounted on the fastening pins 182, 184. Again, the entire arrangement is spray-coated with elastomer compound 188. Transmission of tensile load is effected via the loop packets 130, and transmission of compressive load is effected via the central loop packet 186.

The embodiment according to FIGS. 48 to 50 shows a coupling 190 realized in a manner similar to that of the coupling described with reference to FIGS. 1 to 4, and again the same references are used for components that are of the same type or that operate in the same manner. Evident in the case of this coupling, likewise, is a body 24 or 26, which projects in the form of a tube and to which there are attached transversely extending fastening pins 28, 30 for mounting a central loop packet 32, for the purpose of transmitting tensile force. It can also be seen that headed pins 192, 194 are additionally fitted in the tubular portions 24, 26. These headed pins serve to mount loop packets 196, which extend radially outside of these tubular portions 24 and 26. It can be seen that the pins 192 and 194 are disposed with an offset of approximately 90° in relation to each other. This enables the loop packets 196 to be disposed along a helical line. In the completed state, as shown, for instance, in FIGS. 48 and 50, in addition to tensile and compressive loads, torsional loads can therefore be transmitted via the loop packets 196 extending with a circumferential component.

In the embodiment shown, two such loop packets 196, extending along a helical line, are provided over the circumference.

FIG. 51 shows an embodiment in which a coupling 200 is provided with a first coupling part 202 and a second coupling part 204. The second coupling part 204 is realized in the form of a sleeve. This coupling part is connected, via a connecting sleeve 206 screwed on to an external screw-thread portion 208, to a coupling sleeve 210 that likewise has an external screw-thread portion 212. Respective fastening pins 214, 216 are inserted in the two sleeve portions. In addition, two fastening pins 218, 220 are inserted in the coupling part 202, at the free end thereof. A respective first loop packet 222 is wound around the fastening pins 214 and 218. A respective second loop packet 224 is wound around the fastening pins 216 and 220. The loop packets 222 serve to transmit compressive load, whereas the loop packets 224 serve to transmit tensile load. It is to be noted that the arrangement according to FIG. 51 can again be embedded in an elastomer body.

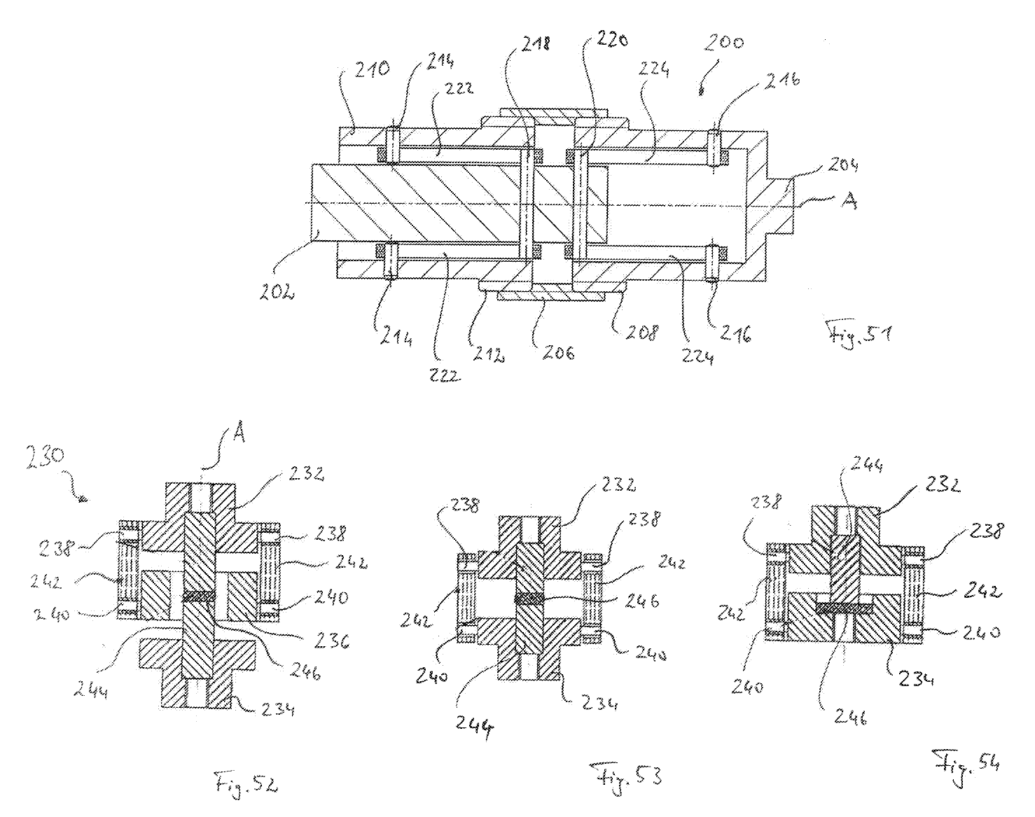

FIG. 52 shows an arrangement of a coupling 230 having a first coupling part 232 and a second coupling part 234, and having an intermediate part 236. The first coupling part 232 has fastening pins 238, which project radially outwards on diametrically opposite sides. The intermediate part 236 has corresponding fastening pins 240, as well as further pins, offset by 90° in relation thereto, outside of the plane of intersection, that project, as it were, forwards and backwards. Correspondingly, the coupling part 234 has fastening pins, such as the fastening pins 238, but turned by 90° about the longitudinal axis A. Like the pins 238 and 240, the fastening pins 240 on the intermediate part 236, which are not shown, and the pins 238 on the coupling part 234, which are likewise not shown, are connected to each other via loop packets 242. The loop packets 242 between the coupling part 232 and the intermediate part 236 are offset, as it were, by 90° in respect of the longitudinal axis A, in relation to the loop packets, not shown, between the intermediate part 236 and the coupling part 234. The intermediate part 236 is hollow. The two coupling parts 232 and 234 are connected to each other via a pin-type compression body 244. In its centre, this compression body has an elastomer damping layer 246. Tensile forces are transmitted via the loop packets 242 in combination with the intermediate part, and is compressive forces are transmitted via the compression body 244. The elastomer layer 246 and the loop packets allow a certain flexibility of the coupling, in particular for the purpose of compensating an axial offset or an axial inclination of the two coupling parts 232, 234.

FIG. 53 shows a simplified embodiment without an intermediate part. Again, tensile forces are transmitted via the loop packets 242, and compressive forces are transmitted via the compression pin 244 and the elastomer layer 246.

Finally, FIG. 54 shows an embodiment in which the compression body 244 is realized without a central elastomer layer, but in which disposed on the coupling part 234 there is an elastomer plate 246, on which the solid compression body 244 is supported.

The coupling arrangement according to FIGS. 52 to 54 can also be embedded in an elastomer body.

1. A coupling for transmitting forces, acting along a longitudinal axis of the coupling, between two attachment components, comprising:
two coupling parts disposed along the longitudinal axis of the coupling and which each have a connection region and a coupler region, the connection regions of the two coupling parts facing towards each other, and the two coupler regions being connectable to a respective attachment component, wherein the two connection regions are connected to each other via at least one loop packet, which is constituted by a thread packet and which transmits forces, acting along the longitudinal axis of the coupling, between the coupling parts.

2. The coupling according to claim 1, wherein the at least one loop packet is provided for transmitting tensile forces, acting along the longitudinal axis, between the two coupling parts.

3. The coupling according to claim 1, wherein the at least one loop packet is fitted on to each coupling part via a respective mounting means, so as to transmit force.

4. The coupling according to claim 3, wherein the mounting means in each case is constituted by a pin that extends out from the coupling part, transversely in relation to the longitudinal axis.

5. The coupling according to claim 1, further comprising a plurality of loop packets, which connect the two coupling parts to each other so as to transmit force.

6. The coupling according to claim 5, wherein a respective mounting means, on to which a respective loop packet is fitted, is provided on at least one coupling part, at diametrically opposite positions.

7. The coupling according to claim 6, wherein the loop packets are offset at angular distances in relation to each other in the circumferential direction.

8. The coupling according to claim 5, characterized in that at least two loop packets extend substantially parallelwise in relation to the longitudinal axis.

9. The coupling according to claim 5, wherein at least one loop packet extends obliquely or in a curved manner in relation to the longitudinal axis.

10. The coupling according to claim 1, further comprising at least one compression body for transmitting compressive forces, acting along the longitudinal axis, between the two coupling parts.

11. The coupling according to claim 10, wherein the at least one compression body comprises a compression pin, which is fixed to one of the two coupling parts and presses against the other of the two coupling parts.

12. The coupling according to claim 10, wherein the at least one compression body comprises a spring means.

13. The coupling according to claim 1, wherein at least one transmission part is provided in the force transmission path between the two coupling parts, which is respectively connected, via at least one loop packet, to at least one of the two coupling parts, so as to transmit force.

14. The coupling according to claim 13, wherein the compression body goes through the at least one transmission part.

15. The coupling according to claim 1, further comprising at least one sleeve body, which at least portionally surrounds at least one of the coupling parts, which is provided with radially inwardly projecting mounting means, on to which a respective loop packet is fitted, so as to transmit force.

16. The coupling according to claim 15, wherein the sleeve body is connected to one of the coupling parts so as to transmit force.

17. The coupling according to claim 15, wherein the sleeve body is realized as a separate component.

18. The coupling according to claim 1, wherein an elastomer body, in which the at least one loop packet is embedded, is disposed between the two coupling parts.

19. The coupling according to claim 1, wherein at least one loop packet, for transmitting compressive force in the direction of the longitudinal axis, is provided between the two coupling parts.

20. The coupling according to claim 1, wherein at least one of the two coupling parts has stop means.
